(19) United States
(12) Patent Application Publication
(10) Pub. No.: US 2025/0148427 A1
(43) Pub. Date: May 8, 2025

(54) Deep Learning and Language Model Enhanced System for Wind Turbine Monitoring Using DistributedFiber Optic Sensing (DL-LM-DFOS)

(71) Applicant: NEC Laboratories America, Inc., Princeton, NJ (US)

(72) Inventors: Yangmin DING, East Brunswick, NJ (US); Ting WANG, West Windsor, NJ (US)

(73) Assignee: NEC Laboratories America, Inc., Princeton, NJ (US)

(21) Appl. No.: 18/935,512

(22) Filed: Nov. 2, 2024

Related U.S. Application Data
(60) Provisional application No. 63/595,898, filed on Nov. 3, 2023.

(51) Int. Cl. G06Q 10/20

(52) U.S. Cl. CPC G06Q 10/20

(57) ABSTRACT

Disclosed is a deep learning and language model enhanced system and method for wind turbine monitoring using distributed fiber optic sensing (DL-LM-DFOS) which combines advantages of distributed fiber optic sensing with the power of deep learning and large language models. Our system and method automatically learns and extracts useful features from raw sensor data, detects complex patterns indicating potential issues, and incorporates and learns from a wide range of data, including textual data such as maintenance logs, operational notes, or alarm messages. As a result, our inventive system and method provide comprehensive, efficient, and predictive monitoring of wind turbines.

### CROSS-REFERENCE TO RELATED APPLICATIONS

This application claims the benefit of U.S. Provisional Patent Application Ser. No. 63/595,898 filed Nov. 3, 2023, the entire contents of which is incorporated by reference as if set forth at length herein.

### FIELD OF THE INVENTION

This application relates generally to distributed fiber optic sensing (DFOS) systems, methods, structures, and related technologies. More particularly, it pertains to a deep learning and language model enhanced system for wind turbine monitoring using DFOS.

### BACKGROUND OF THE INVENTION

Distributed fiber optic sensing (DFOS) systems, methods, and structures have found widespread utility in contemporary industry and society. Of particular importance, DFOS techniques have been used to usher in a new era of monitoring including perimeter security, traffic monitoring, and civil infrastructure monitoring. They can provide continuous, real-time measurements over long distances with high sensitivity, making them valuable tools for infrastructure monitoring and maintenance.

Traditional wind turbine monitoring methods often rely on a limited set of sensors, such as vibration sensors, temperature sensors, and anemometers. These sensors provide valuable data, but their coverage is limited to specific points on the turbine. As a result, they fail to sense critical signs of potential issues in areas they don't cover. Additionally, these sensors often operate in isolation, meaning they don't share data with each other. This can lead to a lack of context in the data, making it harder—or impossible—to detect complex issues that affect multiple parts of the turbine.

### SUMMARY OF THE INVENTION

The above problems are solved and an advance in the art is made according to aspects of the present disclosure directed to a deep learning and language model enhanced system and method for wind turbine monitoring using distributed fiber optic sensing (DL-LM-DFOS) which combines advantages of distributed fiber optic sensing with the power of deep learning and large language models.

In sharp contrast to the prior art, systems and methods according to aspects of the present disclosure automatically learn and extract useful features from raw sensor data, detect complex patterns indicating potential issues, and incorporate and learn from a wide range of data, including textual data such as maintenance logs, operational notes, or alarm messages. As a result, our inventive systems and methods provide comprehensive, efficient, and predictive monitoring of wind turbines.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagrams showing illustrative distributed learning and language model enhanced system for wind turbine monitoring using distributed fiber optic sensing (DL-LM-DFOS) according to aspects of the present disclosure.

FIG. 3 is a schematic flow diagram showing illustrative DL-LM-DFOS component flow according to aspects of the present disclosure.

FIG. 4 is a schematic flow diagram showing illustrative convolutional neural network and long short-term memory (CNN-LSTM) architecture according to aspects of the present disclosure.

FIG. 5 is a schematic flow diagram showing illustrative large language model architecture according to aspects of the present disclosure.

FIG. 6 is a schematic flow diagram showing illustrative predictive monitoring flow according to aspects of the present disclosure.

FIG. 7 is a schematic diagram showing illustrative feature hierarchy of systems and methods according to aspects of the present disclosure.

FIG. 8 is a schematic block diagram of an illustrative computing system that may be programmed with instructions that when executed produce the methods/algorithms according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we note that distributed fiber optic sensing systems convert the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

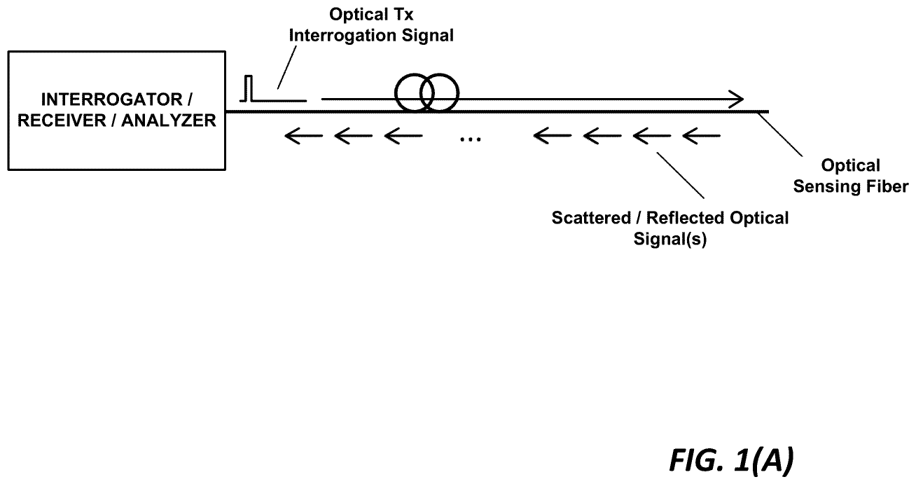

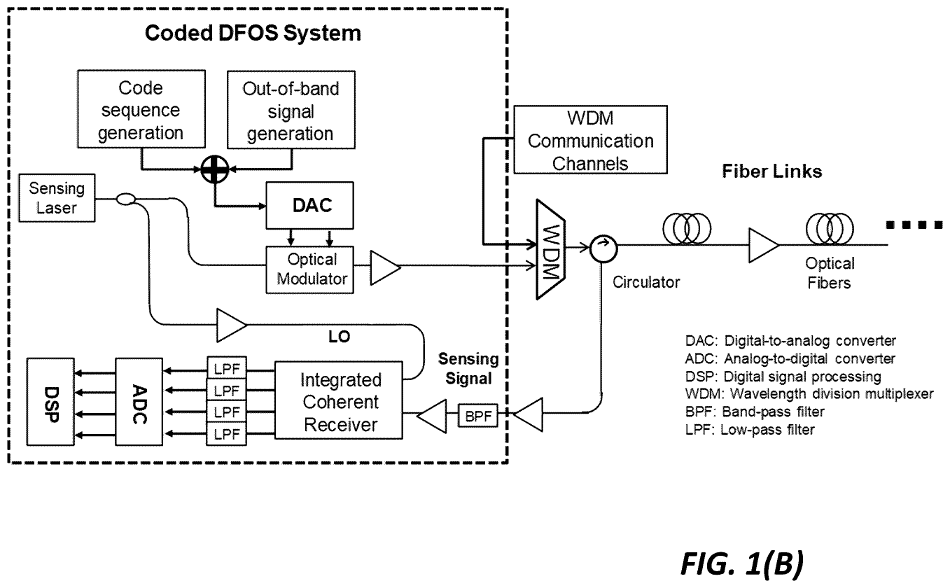

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects/analyzes reflected/backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Of particular interest, distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows for continuous monitoring over long distances, but instead of measuring temperature, it measures vibrations and sounds along the fiber.

DAS/DVS operates as follows.

Light pulses are sent through the fiber optic sensor cable.

As the light travels through the cable, vibrations and sounds cause the fiber to stretch and contract slightly.

These tiny changes in the fiber's length affect how the light interacts with the material, causing a shift in the backscattered light's frequency.

By analyzing the frequency shift of the backscattered light, the DAS/DVS system can determine the location and intensity of the vibrations or sounds along the fiber optic cable.

Similar to DTS, DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technology has a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

With the above in mind, we note once more that traditional wind turbine monitoring methods often rely on a limited set of sensors, such as vibration sensors, temperature sensors, and anemometers. These sensors provide valuable data, but their coverage is limited to specific points on the turbine. They can miss critical signs of potential issues in areas they don't cover. Additionally, these sensors often operate in isolation, meaning they don't share data with each other. This can lead to a lack of context in the data, making it harder to detect complex issues that affect multiple parts of the turbine.

Moreover, traditional methods often lack the capabilities to effectively analyze the large amounts of data generated by these sensors. Important signs of potential issues, such as subtle changes in vibration patterns or temperature gradients, might be overlooked. These methods are also typically reactive, detecting issues after they occur, rather than being predictive.

On the other hand, distributed fiber optic sensing offers several advantages that make it a superior solution for wind turbine monitoring.

Comprehensive Coverage: Distributed fiber optic sensing can measure parameters like strain, temperature, and vibration at thousands of points along the fiber. This means they can provide comprehensive coverage of the entire turbine, including the blades, tower, nacelle, and even the internal components like the gearbox and generator.

High-Dimensional Data: Distributed fiber optic sensors generate high-dimensional data, capturing detailed information about the turbine's condition in both space and time. This rich data can reveal complex patterns and subtle changes that might be missed by traditional sensors.

Existing Infrastructure: Optical fiber cables are already present in many wind turbines, running up to the nacelle box. This existing infrastructure can be leveraged for distributed fiber optic sensing, making it a cost-effective solution.

Immunity to Electromagnetic Interference: Unlike traditional electronic sensors, fiber optic sensors are immune to electromagnetic interference. This makes them more reliable in the electrically noisy environment of a wind turbine.

Accordingly, those skilled in the art will readily understand and appreciate that our systems and methods according to the present disclosure namely, our “Deep Learning and Language Model Enhanced System for Wind Turbine Monitoring Using Distributed Fiber Optic Sensing (DL-LM-DFOS)”, combines advantages of distributed fiber optic sensing with the power of deep learning and large language models. Our systems and methods automatically learn and extract useful features from the raw sensor data, detect complex patterns indicating potential issues, and incorporate and learn from a wide range of data, including textual data such as maintenance logs, operational notes, or alarm messages. This makes our systems and methods a comprehensive, efficient, and predictive monitoring solution for wind turbines.

Our inventive systems and methods therefore significantly advance the state of the art. They leverage comprehensive coverage and high-dimensional data provided by distributed fiber optic sensing, which utilizes existing optical fiber infrastructure in wind turbines, to capture detailed information about the turbine's condition in both space and time.

Our inventive system and method introduces a novel combination of deep learning and large language models to automatically learn and extract useful features from the raw sensor data, detect complex patterns indicating potential issues, and incorporate and learn from a wide range of data, including textual data such as maintenance logs, operational notes, or alarm messages.

As will become apparent to those skilled in the art, our inventive system and method according to aspects of the present disclosure advantageously overcomes limitations of traditional monitoring methods, providing early and accurate detection of a wide range of potential issues, from cable strain and blade icing to generator faults and structural fatigue. By doing so, our system and method prevent equipment failure and downtime, improving the efficiency and reliability of wind turbines-thereby representing the significant advancement in wind farm monitoring technology.

As we shall show and describe further, particularly inventive features of our system and methods include the following.

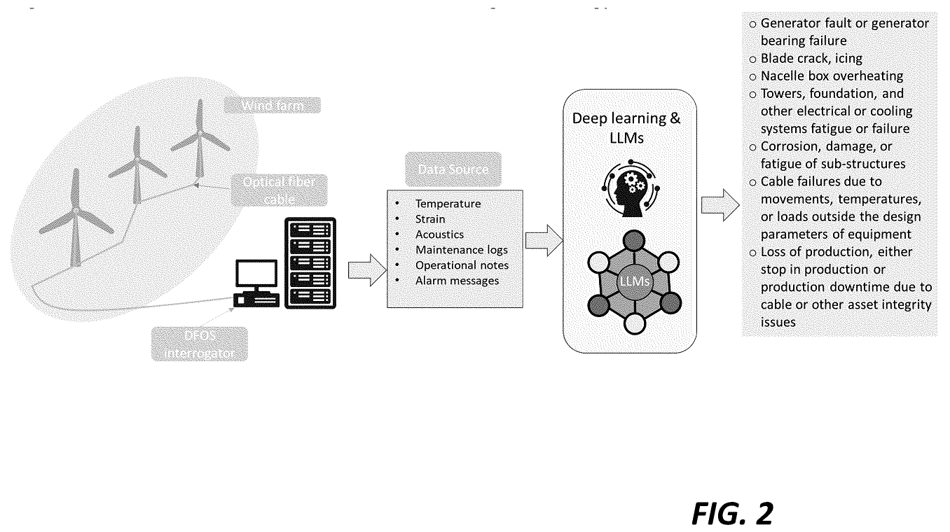

FIG. 2 is a schematic diagrams showing illustrative distributed learning and language model enhanced system for wind turbine monitoring using distributed fiber optic sensing (DL-LM-DFOS) according to aspects of the present disclosure.

Distributed Fiber Optic Sensing: This feature provides comprehensive coverage of the entire wind turbine, capturing high-dimensional data about strain, temperature, vibration, and more at thousands of points along the fiber. This allows for the detection of complex patterns and subtle changes that might be missed by traditional sensors.

Deep Learning: The system uses a combination of Convolutional Neural Networks (CNNs) and Long Short-Term Memory (LSTM) networks to process the spatial and temporal data from the sensors. This allows the system to automatically learn and extract useful features from the raw sensor data, eliminating the need for manual feature engineering.

Large Language Model: The system incorporates a large language model to process and interpret any textual data associated with the sensor data, such as maintenance logs, operational notes, or alarm messages. This provides additional context that can help in diagnosing potential issues.

Predictive Monitoring: By learning from the sensor data and associated textual data, the system can detect potential issues before they lead to failures. This predictive capability is a significant advancement over traditional reactive monitoring methods.

Utilization of Existing Infrastructure: The system leverages the existing optical fiber cables in wind turbines for distributed fiber optic sensing. This makes it a cost-effective solution that can be easily implemented in existing wind farms.

These and other inventive features work together to provide a comprehensive, efficient, and predictive monitoring solution for wind turbines, significantly advancing the state of the art in wind farm monitoring technology.

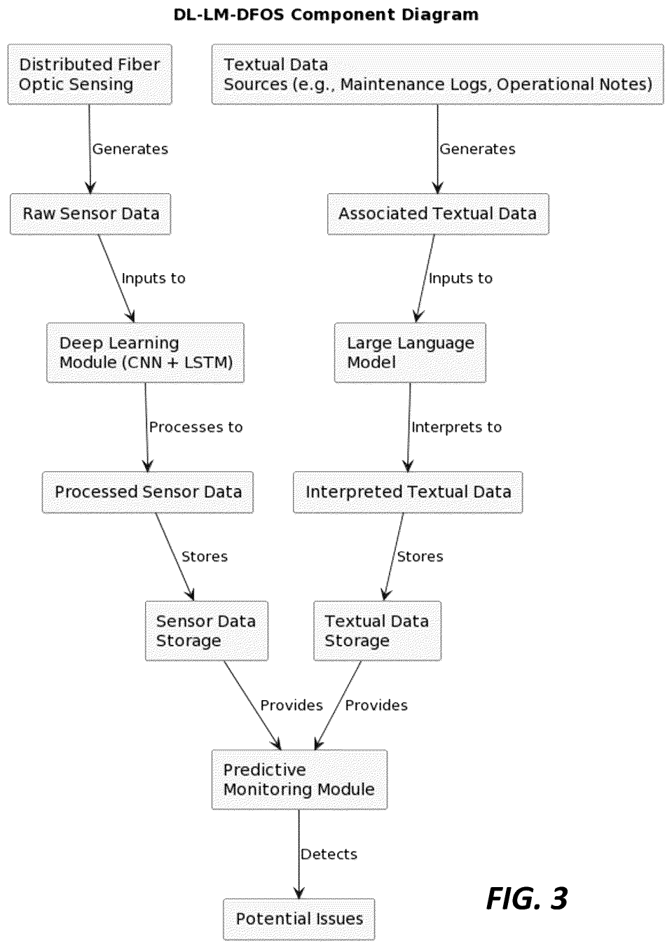

FIG. 3 is a schematic flow diagram showing illustrative DL-LM-DFOS component flow according to aspects of the present disclosure.

Data Collection: During operation, the system begins by collecting data from two primary sources. The first is the existing optical fiber cables installed throughout the wind turbine. When combined with a DFOS system, these optical fiber cables act as sensors, generating high-dimensional data that captures detailed information about strain, temperature, vibration, and more at thousands of points along the length of the optical fiber. This comprehensive coverage is a significant advancement over traditional sensors, which may only monitor a limited number of points.

The second source of data is textual data associated with wind turbine operation, such as maintenance logs, operational notes, or alarm messages. This data provides valuable context that can aid in the interpretation of the sensor data.

Raw Sensor Data Processing: In this operation, raw sensor data, which is high-dimensional and time-series in nature, is fed into a deep learning system/module. This system/module is designed to handle such complex data effectively. The deep learning system/module includes two main components: Convolutional Neural Networks (CNNs) and Long Short-Term Memory (LSTM) networks.

The CNN component is responsible for automatically extracting spatial features from the raw sensor data. CNNs are particularly effective at identifying patterns in spatial data, making them ideal for analyzing the high-dimensional data from the fiber optic sensors. The CNN component has multiple layers, including convolutional layers, pooling layers, and fully connected layers. The convolutional layers apply a series of filters to the data to identify patterns, the pooling layers reduce the dimensionality of the data while preserving the most important features, and the fully connected layers combine these features to make predictions.

The LSTM component is responsible for analyzing the temporal aspects of the sensor data. LSTMs are a type of recurrent neural network that are capable of learning long-term dependencies in time-series data. This makes them ideal for analyzing the sensor data, which is collected over time and may contain temporal patterns that are indicative of potential issues. The combination of CNNs and LSTMs in this way is a novel aspect of this system. By using CNNs to extract spatial features and LSTMs to analyze temporal patterns, the system can effectively learn from the high-dimensional, time-series sensor data.

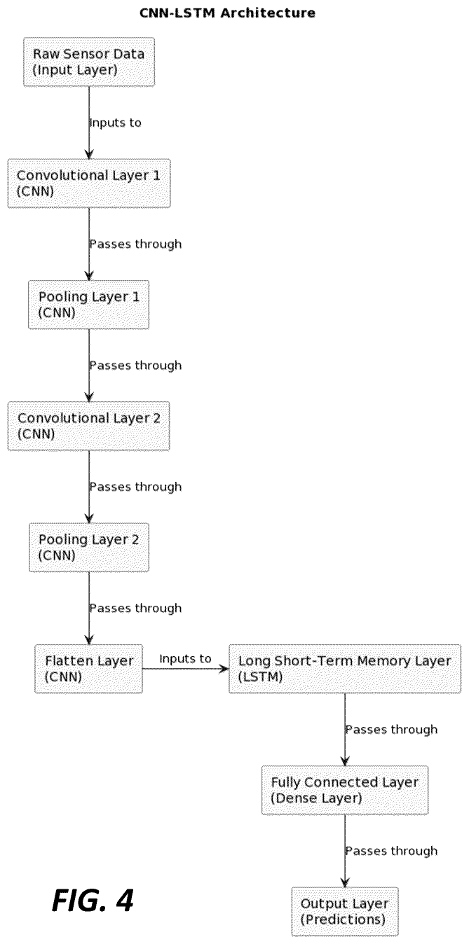

FIG. 4 is a schematic flow diagram showing illustrative convolutional neural network and long short-term memory (CNN-LSTM) architecture according to aspects of the present disclosure.

Textual Data Processing: In this step, the associated textual data, such as maintenance logs, operational notes, or alarm messages, is inputted into a large language model. This model is a type of transformer-based neural network, specifically designed to understand and generate human-like text.

The large language model processes the textual data in the following ways.

Tokenization: The textual data is first broken down into smaller pieces, or tokens. These tokens can be as short as one character or as long as one word.

Embedding: Each token is then mapped to a high-dimensional vector that represents it in a way the model can understand. This process is known as embedding.

Contextual Understanding: The model processes the sequence of embedded tokens, taking into account the order of the tokens and the relationships between them. This allows the model to understand the context of each token within the text.

Interpretation: The model uses its understanding of the text's context to interpret the text, providing additional context that can help in diagnosing potential issues.

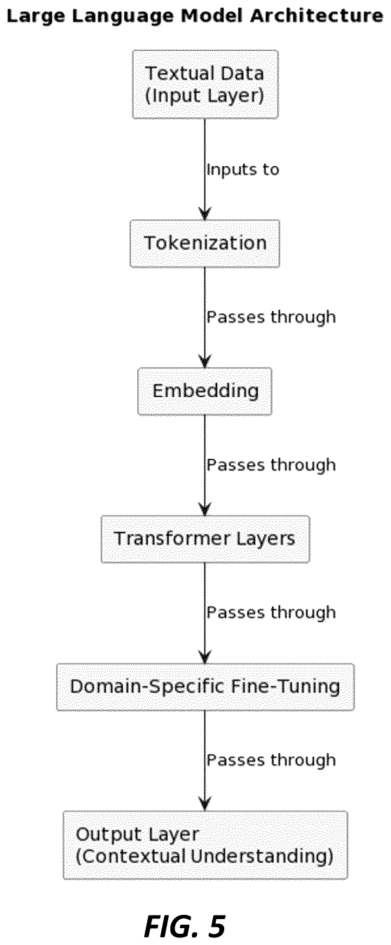

FIG. 5 is a schematic flow diagram showing illustrative large language model architecture according to aspects of the present disclosure.

One particularly distinguishing aspect of our inventive system and method results from the domain-specific fine-tuning of the large language model. Specifically, the model is fine-tuned on a dataset of wind turbine maintenance logs and operational notes. This allows the model to better understand the specific language and terminology used in this domain, improving its ability to interpret the textual data and provide useful context for diagnosing potential issues. This domain-specific fine-tuning of the large language model, combined with the deep learning module (CNN +LSTM) and distributed fiber optic sensing data, provides a comprehensive, efficient, and predictive monitoring solution for wind turbines. This represents a significant advancement in wind farm monitoring technology.

Data Storage: The processed sensor data and interpreted textual data are then stored in separate data storage systems. This allows the data to be easily accessed and analyzed in the future.

Predictive Monitoring: The stored data is provided to a predictive monitoring module, which analyzes the data to detect potential issues. By learning from the sensor data and associated textual data, the system can detect potential issues before they lead to failures. The processed sensor data (output from the CNN-LSTM model) and the interpreted textual data (output from the large language model) are inputted into the feature extraction process. The feature extraction process extracts relevant features from both types of data. The extracted features are then used to make a prediction about potential issues. If a potential issue is predicted, an alert is triggered.

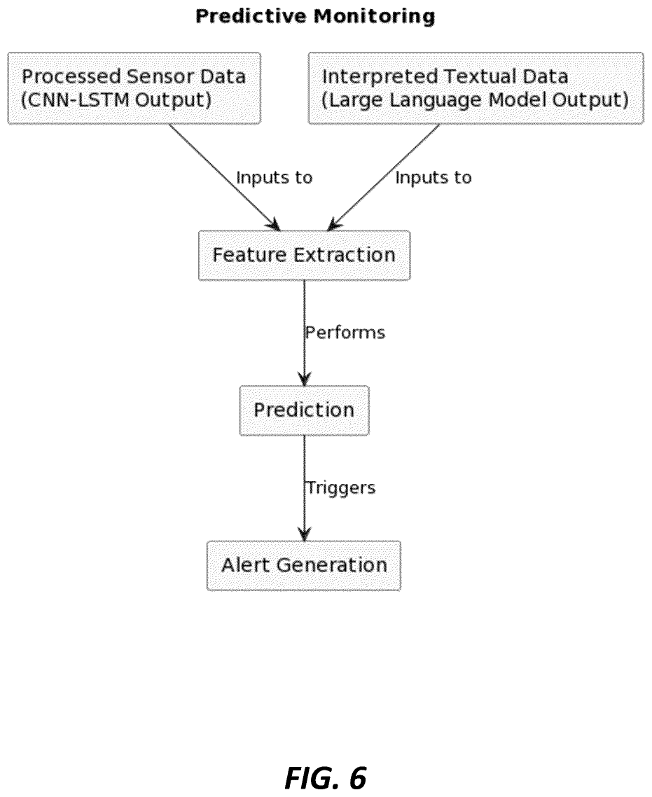

FIG. 6 is a schematic flow diagram showing illustrative predictive monitoring flow according to aspects of the present disclosure.

Issue Detection: If the predictive monitoring module detects a potential issue, it alerts the relevant personnel or systems. This allows for early intervention, potentially preventing equipment failure and downtime

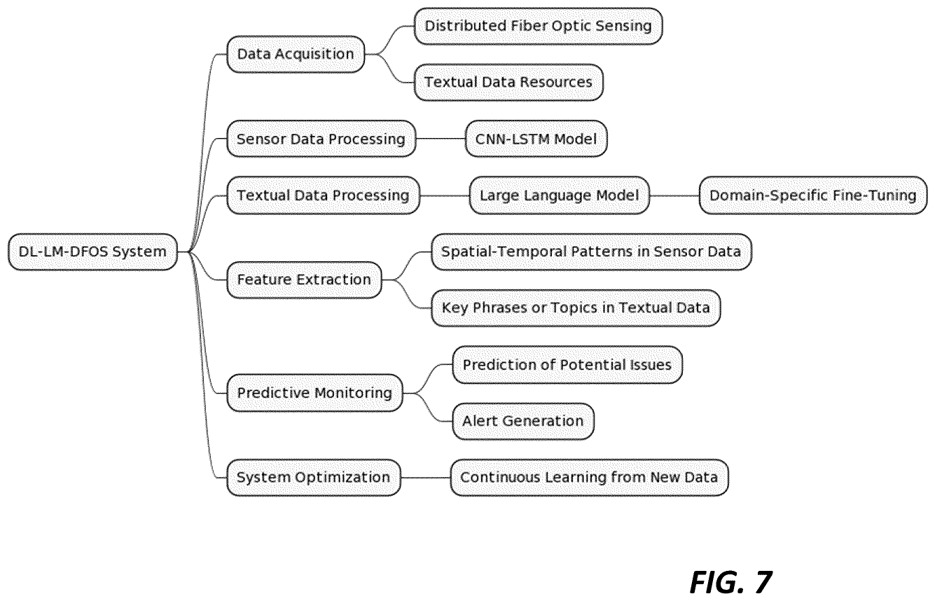

FIG. 7 is a schematic diagram showing illustrative feature hierarchy systems and methods according to aspects of the present disclosure.

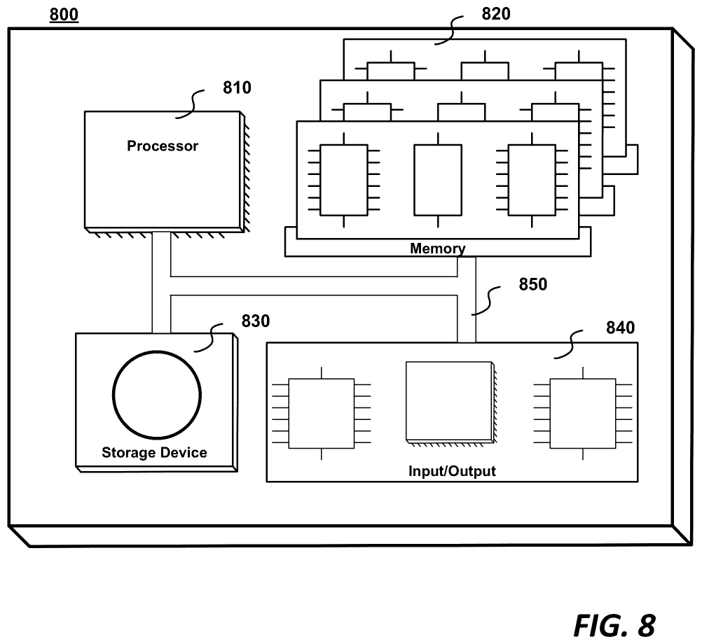

FIG. 8 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of a number of operating systems. The above-described methods of the present disclosure may be implemented on the computer system 800 as stored program control instructions.

Computer system 800 includes processor 810, memory 820, storage device 830, and input/output structure 840. One or more input/output devices may include a display 845. One or more busses 850 typically interconnect the components, 810, 820, 830, and 840. Processor 810 may be a single or multi core. Additionally, the system may include accelerators etc., further comprising the system on a chip.

Processor 810 executes instructions in which embodiments of the present disclosure may comprise steps described in one or more of the Drawing figures. Such instructions may be stored in memory 820 or storage device 830. Data and/or information may be received and output using one or more input/output devices.

Memory 820 may store data and may be a computer-readable medium, such as volatile or non-volatile memory. Storage device 830 may provide storage for system 800 including for example, the previously described methods. In various aspects, storage device 830 may be a flash memory device, a disk drive, an optical disk device, or a tape device employing magnetic, optical, or other recording technologies.

Input/output structures 840 may provide input/output operations for system 800.

While we have presented our inventive concepts and description using specific examples, our invention is not so limited. Accordingly, the scope of our invention should be considered in view of the following claims.

1. A deep learning and language model enhanced system for wind turbines using distributed fiber optic sensing (DL-LM-DFOS) comprising:
a distributed fiber optic sensing (DFOS) system for capturing high-dimensional data about strain, temperature, or vibration of the wind turbines;
a deep learning system for automatically learn and extract features from raw DFOS sensor data; and
a large language model for processing and interpreting textual data associated with the DFOS sensor data;
wherein the DL-LM-DFOS enhanced system is configured to detect maintenance issues from the
fiber optic sensing (DFOS) sensor data and the textual data.

2. The DL-LM-DFOS enhanced system of claim 1 wherein the deep learning system comprises a combination of convolutional neural networks (CNNs) and long short-term memory (LSTM) networks to learn and extract the features from the raw DFOS sensor data.

3. The DL-LM-DFOS enhanced system of claim 2 wherein the textual data associated with the DFOS sensor data includes maintenance logs, operational notes, or alarm messages.

4. The DL-LM-DFOS enhanced system of claim 3 wherein the DFOS system includes an optical fiber method of claim 1 in which the resources allocated are selected from the group consisting of repair crews, equipment, and material.

5. The DL-LM-DFOS enhanced system of claim 4 wherein the DL-LM-DFOS system is configured to report detected maintenance issues to appropriate maintenance personnel.

6. The DL-LM-DFOS enhanced system of claim 5 wherein the detected maintenance issue is a generator fault or generator bearing failure.

7. The DL-LM-DFOS enhanced system of claim 5 wherein the detected maintenance issue is a blade crack or icing condition.

8. The DL-LM-DFOS enhanced system of claim 5 wherein the detected maintenance issue is an overheating condition.

9. The DL-LM-DFOS enhanced system of claim 5 wherein the detected maintenance issue is a corrosion issue.

10. The DL-LM-DFOS enhanced system of claim 5 wherein the detected maintenance issue is a cable failure due to movement, temperature, or load outside operational design parameters.
